(19) United States
(12) Patent Application Publication
(10) Pub. No.: US 2005/0103948 A1
(43) Pub. Date: May 19, 2005

(54) Shell assemblies for encircling tubular members

(76) Inventors: Dan Quoc Vu, Loughborough (GB); Satuinder Chana, Oadby (GB)

Correspondence Address: Kenneth R Schaefer, 25 Dickinson Road, Basking Ridge, NJ, 07920, US

(21) Appl. No.: 10/504,720

(22) PCT Filed: Feb. 13, 2003
(86) PCT No.: PCT/GB03/00690

(30) Foreign Application Priority Data
Feb. 15, 2002 (GB) 0203639.0

(51) Int. Cl. F16L 3/08

(52) U.S. Cl. 248/65

(57) ABSTRACT

A shell assembly 1 for securing to a tubular member 50 comprises a first part 2 for locating on the tubular member, and second and third parts 4, 6 respectively hinged 8, 10 to opposite sides of the first part. The parts 4 and 6 each have engaging means 40 or 42 complementary to that of the other part. Remotely operable means 20 is used to move the parts 4 and 6 and about hinges 8 and 10 to respective positions whereat the engaging means 40 and 42 interengage so that the parts 4 and 6 are secured together. The shell assembly may be employed in subsea operations to support a damaged region of a pipeline or to enable a branch or tee to be secured to a pipeline.

### FIELD OF THE INVENTION

The present invention relates to shell assembles for encircling and securing to tubular or hollow members, such as pressurized or unpressurized vessels, containers or pipelines, and more particularly to a remotely operable shell assembly for securing to a submerged or sub-sea vessel or pipeline.

### BACKGROUND OF THE INVENTION

Such shell assemblies may be in the form of clamps that encircle an object, for example a steel pipeline, to surround and support a damaged region of the pipeline wall and thus serve to repair the pipeline.

Such shell assemblies, instead of serving as repair clamps, may include a tee or branch whereby securing of the assembly to the pipeline provides the pipeline with a tee or branch connection.

The pipeline may be a gas or water main or may be a pipeline for conveying chemical fluids, such as hydrocarbons.

An object of the invention is to provide a shell assembly remotely operable to be secured in an encircling position on a tubular member, such as a pipeline.

### STATEMENT OF THE INVENTION

The present invention provides a shell assembly for securing to a tubular member and comprises a first part for locating on the tubular member, second and third parts respectively movably connected to opposite sides of the first part, the second and third parts each having a locking or engaging means complementary to that of the other part, and means remotely operable to move the second and third parts to respective positions whereat the complementary locking or engaging means interengage so that the second and third parts are locked or secured together. In use, when the shell assembly is mounted in its desired position on, for example, a pipeline, the assembly encircles the pipeline with the second and third assembly parts in their interengaged or secured-together positions.

When the second and third parts are in the mutually interlocked or interengaged positions, forces which act to urge the second and third parts in directions outwardly of the assembly serve to tighten the interlocking or interengaging between those parts.

Conveniently, the second and third parts of the assembly are movably connected to the first part by means of respective hinge (or pivotal) connections about which the second and third parts are remotely movable to their respective interlocked or interengaged positions.

The remotely operable means may comprise hydraulically operable means which act through pivot means to move the second and third parts to their interlocked positions.

The second and third parts may be operable to be movable generally inwardly of their interlocked or interengaged positions, prior to being moved outwardly therefrom to their interlocked or interengaged positions.

In one arrangement, when the second and third parts are in their respective interlocked or interengaged positions, the internal cross-section of the shell assembly is generally circular, which is appropriate for use on a normal pipeline.

The second and third parts may each have a plurality of locking or engaging means complementary to those of the other part.

Preferably, the second and third parts each have a row of formations and recesses that interlock or interengage with complementary recesses and formations of the other part to form a row of dovetail-like joints securing the second and third parts together. The advantages of these kind of dovetail-like joints between the second and third parts are that due to a tapered design, once they are fully engaged, any forces applied in such a manner as to try and pull the joints apart results in pulling the two mating tapers together, thus increasing the tightness of the joint and thereby locking the second and third parts together even more securely.

Optionally, hydraulically operated jacking means may be employed to space the second and third parts from the pipeline when the shell assembly is mounted on the pipeline with the second and third parts in their interengaged positions.

For example, the jacking means may comprise a jacking member slidably mounted in an aperture in each of the second and third parts and respective pressure-applying means mounted with respect to the second and third parts and behind the associated jacking member and being urgeable under hydraulic pressure against the jacking member to cause the jacking members to be urged towards the pipeline to positions to space the second and third parts from the pipeline.

Conveniently, the jacking members are slidably mounted in bosses or the like secured or fixed to the second and third parts in which case the pressure-applying members are also slidably mounted in the bosses or the like.

Conveniently, one or more load bearing members are positioned between the pipeline and the jacking members to spread the applied load when the jacking members are in position spacing the second and third parts from the pipeline.

The load bearing members may be in the form of enlarged feet on the jacking members, the surfaces of which feet may generally correspond to the profile of the pipeline. Alternatively, the load bearing members may be secured to the pipeline, in positions so that they will be engaged or contacted by the jacking members.

It will be appreciated that a plurality of jacking means may be mounted on both the second and third parts.

### DESCRIPTION OF THE DRAWINGS

In order that the invention may be more readily understood, reference will now be made, by way of example only, to the accompanying drawings, in which:

FIG. 1 shows schematically a view from one end of one embodiment of a shell assembly according to the invention mounted on a pipeline;

FIG. 2 is a view in the direction of arrow A in FIG. 1 showing opposite end portions of the shell assembly, with the central portion and the second and third parts being omitted from this figure;

FIG. 3 is a partial end view showing the second and third parts having been pivoted to respective positions just prior to the locking means becoming engaged;

FIG. 4 is a partial end view similar to FIG. 3 with the locking means of the second and third parts fully engaged;

FIG. 5 shows schematically a view from one end, of another embodiment of a shell assembly according to the invention with the hydraulically operated means omitted;

FIG. 6 is a perspective view of the second and third parts of the embodiment of FIG. 5, with the remainder of the shell assembly omitted, showing the dovetail-joint like locking means;

FIG. 7 is another perspective view of the second and third parts; and

FIG. 8 is a further perspective view of the second and third parts showing the complementary dovetail-joint like locking means of the two parts fully engaged.

### DETAILED DESCRIPTION

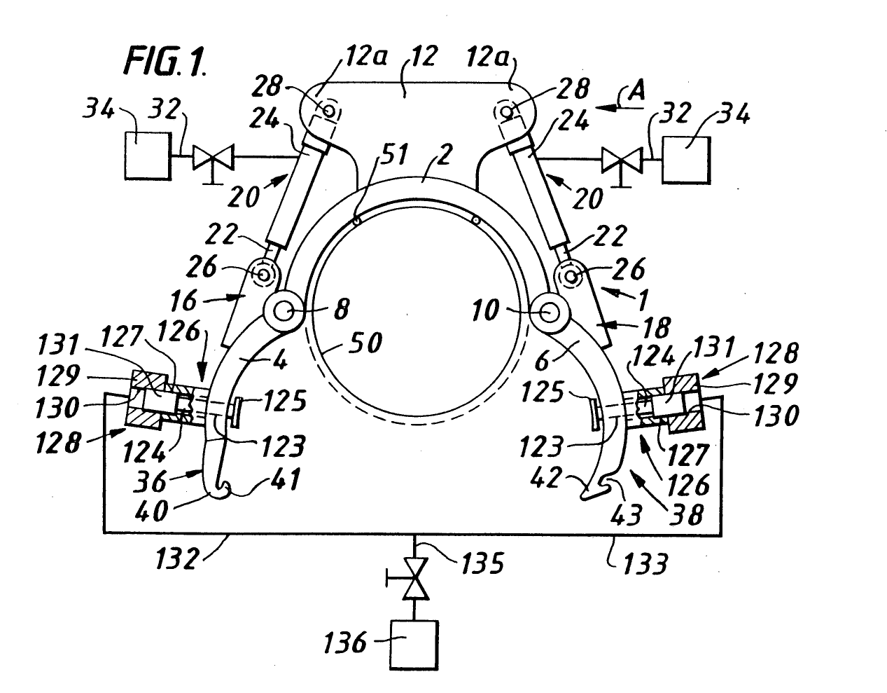

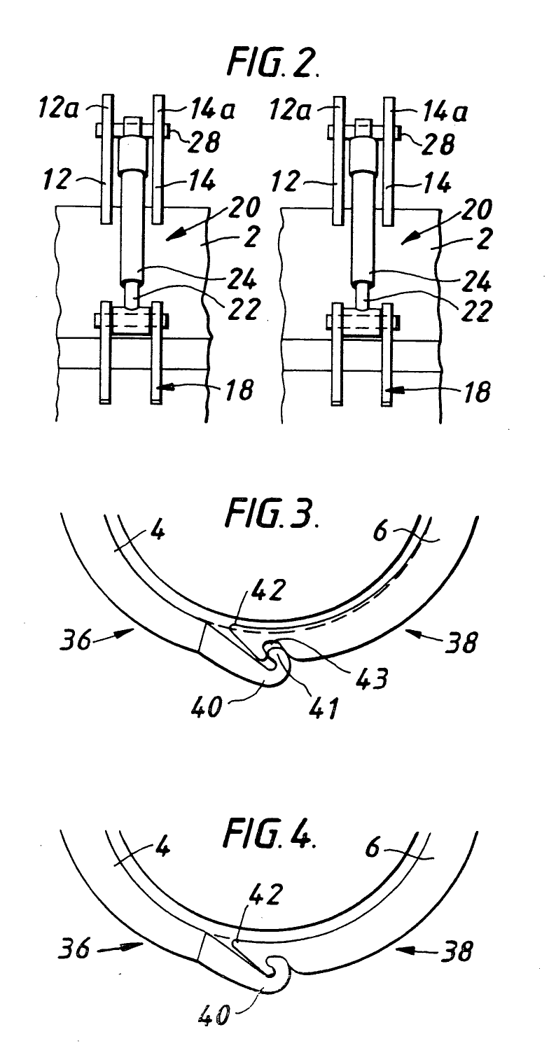

Referring to FIGS. 1 and 2, a shell assembly 1 made for example of a high strength steel, comprises a first semi-circular arcuate part 2. On opposite sides of the first part are second and third arcuate parts 4 and 6, respectively, pivotally connected as at 8 and 10 to the first part.

Towards each end of the first arcuate part 2 (see FIG. 2) are two upstanding spaced plate-like members 12 and 14 both having laterally extending lug portions 12a and 14a. On each of the second and third parts 4 and 6 is a pair of space lugs 16 and 18 aligned with associated lug portions 12a and 14a on the first part.

Hydraulically operated means 20 comprising piston/cylinder assemblies 22,24 are provided with each piston 22 mounted at one end on a pivot pin 26 supported between the lugs 16 and 18 and with the cylinder 24 mounted at the other end on a pivot pin 28 supported between the lug portions 12a and 14a.

Hydraulic pressure is applied to the respective cylinders 24 through supply lines 32 connected to a source 34 of hydraulic pressure.

The free end portions 36 and 38 of the second and third parts 4 and 6, i.e. the end portions remote from the pivot points 8 and 10, each have a locking means 40 and 42, respectively, complementary to that of the other part. In this embodiment the locking means 40 is in the form of a hook 41 that extends along the length of the second part 4, while the complementary locking means 42 comprises a recessed region 43 that extends along the length of the third part 6.

The piston assemblies are operated remotely by means of hydraulic fluid supplied to the assemblies 22/24 via supply lines 32.

Each of the parts 4 and 6 is provided with an aperture 123 in which is slidably mounted a jacking member 124 carrying enlarged feet 125 to match the profile of the pipeline and are for engaging or contacting the surface of the pipeline. Bosses 126 having through bores 127 are secured to the parts 4 and 6. The through bores 127 are for slidably receiving the free, outer ends of the jacking members 124. Hydraulically operated means 128 comprising cylinder means 129 are mounted on the bosses 126. Each cylinder means 129 comprises a cylinder 130 and a pressure-applying means 131 in the form of a piston which is slidably mounted in the cylinder 130. The cylinders 130 are aligned with respective ones of the bores 127 of the bosses 126. The pistons are also slidably mounted in the bores 127 of the bosses 126. Hydraulic pressure is applied through lines 132 and 133, to the respective cylinders 130 from a common main line 135 to a source 136 of hydraulic pressure.

In use, the shell assembly 1 may be mounted, for example on a subsea pipeline with the first part resting on the top of the pipeline 50, for example via spacers and/or sealing means or a sealing arrangement of e.g. annular/saddle form 51 for surrounding a damaged area, or area to be accessed on the pipeline or other equivalent means (not shown) known to those skilled in the art.

The piston/cylinder assemblies 22/24 are supplied with hydraulic fluid so that the assemblies act between the pivot pins 26 and 28 to pivot the second and third parts about the pivot points 8 and 10. The movements of the second and third parts are controlled so that the part 6 having the recessed portion 43 is pivoted to a position generally radially inwardly of its final position, and part 4 comprising the hook part 41 is pivoted to a position such that pivotal movement outwardly of the part 6 causes initial engagement of the hook part 41 and the complementary recess 43 in the part 4. See FIG. 3.

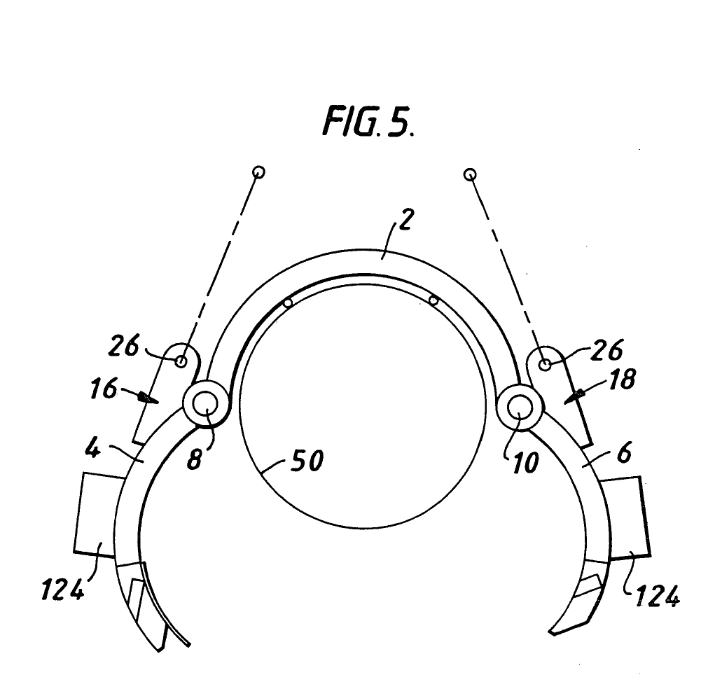

Thereafter, the piston/cylinder assemblies are remotely operated so that the two parts 4 and 6 are moved pivotally outwardly to cause the two parts to move to respective positions whereat they are securely engaged/locked together (see FIG. 4), and which together with the first arcuate part 2 form a circular shell or concentric assembly about the pipeline.

On applying appropriate hydraulic pressure to the cylinders 130, the pistons 131 are urged against the jacking members 124 to cause the jacking members to be urged towards and against the pipeline 50 such that the annular seal 51 is compressed.

The enlarged feet 125 serve as load bearing members that spread the load applied to the pipeline via the jacking members.

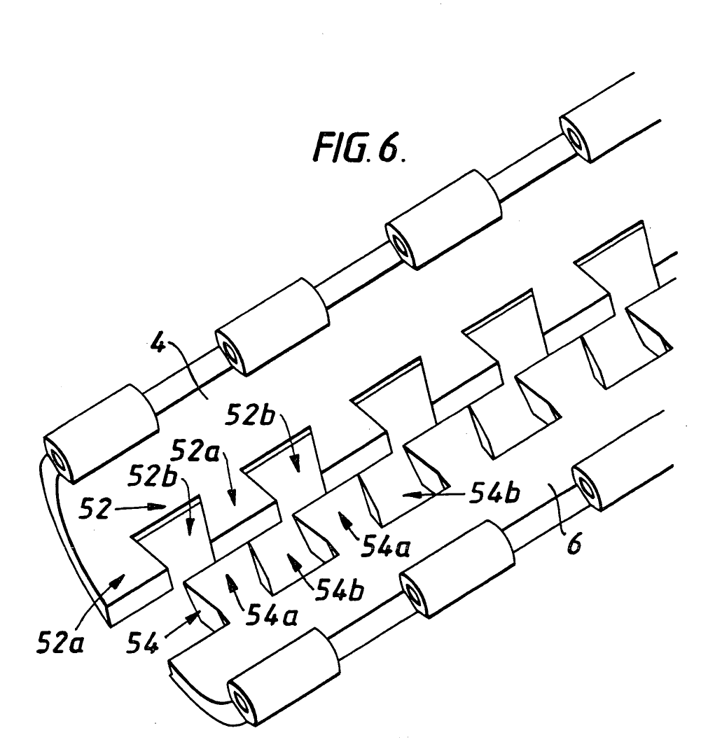

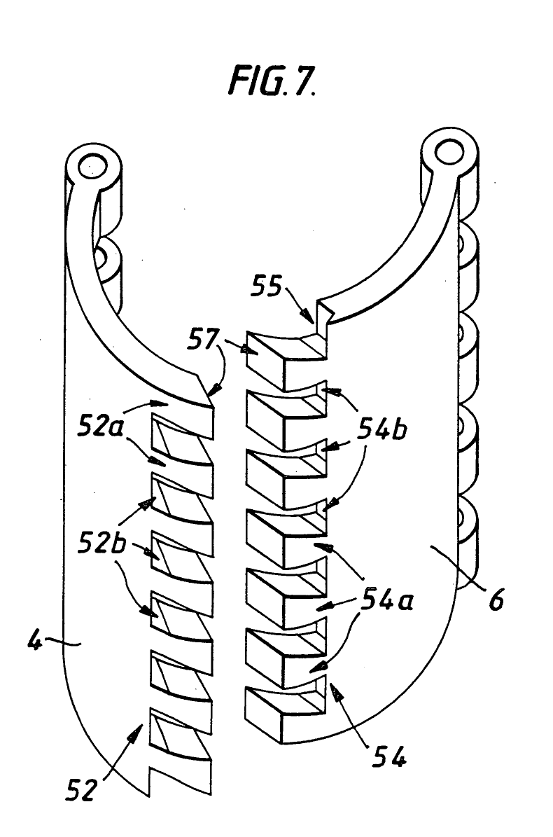

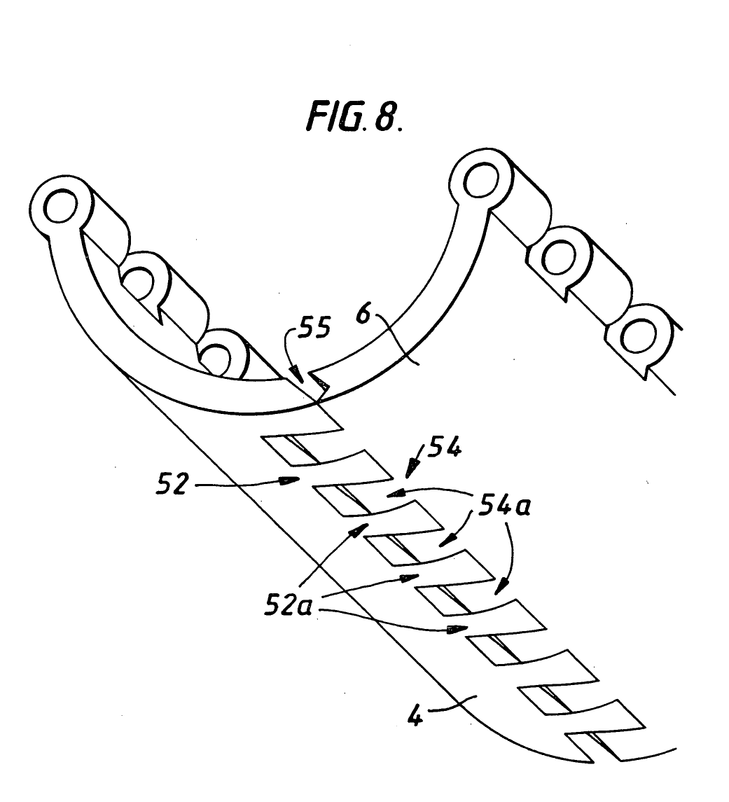

In a second embodiment, as shown in part in FIGS. 5 to 8, the second and third arcuate parts, 4 and 6, instead of being provided with a hook and complementary receiving recessed portion, respectively, are each provided with a plurality of locking or engaging means 52 and 54 complementary to those of the other part. Each plurality of locking means 52, 54 comprises a row of alternating formations 52a, 54a and recesses 52b, 54b for interlocking with the complementary recesses and formations of the other part to form a row of dovetail-like joints 56 as seen in FIG. 8 securing the second and third parts together.

Apart from the form of the interengaging or locking means on the second and third parts, the construction of the rest of the shell assembly in the second embodiment, including the hydraulically operated piston/cylinder means is essentially the same as that shown in FIGS. 1 and 2, and therefore have not been included in the figures of the second embodiment. Moreover, this second embodiment is provided with the same hydraulically operated jacking means, associated with the parts 4 and 6, as in the first embodiment, and these are indicated schematically in FIG. 5 by boxes 124.

The second embodiment of shell assembly is mounted on the pipeline in the same way as the first embodiment and the remote operation to move the second and third parts into their final locked positions is also similar to that used in the first embodiment. It will be understood that the design and dimensions of the formations 52a, 54a and recesses 52b, 54b are such that once the second and third parts are securely locked together, in their final rest positions, any further urging of the two parts outwardly of the pipeline serves to tighten or lock the second and third parts together more.

To facilitate movement of the formations 52a, 54a into the recesses 54b, 52b when the second and third parts are moved outwardly from positions generally inwardly of the fully interlocked positions to their interlocked or interengaged positions the back walls of the recesses 52b, 54b have cut out chamfered-liked portions 55 which ease the entry of the leading edges 57 of the formations 54a, 52a into the recesses 52b, 54b.

Although not shown in the embodiments described above, it will be appreciated that the first part 2 of the shell assembly may include a branch, e.g. Y, tee or K whereby a branch pipeline can be joined to the pipeline via a tee or access to the pipeline can be gained via the limb or limbs of the Y, K or tee branch for access. Thus, the branch, Y, tee or K on the shell assembly may be designed and constructed in a manner known to those skilled in the art to allow access selectively to the interior of the pipeline. In either case, appropriate annular seals would as usual be provided between the first part of the shell assembly and the pipeline around the opening of the branch or tee.

Although the opposing or mating faces of the tapering sides of the dove-tail like alternating formations 52a, 54a and recesses 52b and 54b are shown as planar in the drawings throughout the depth of the formations/recesses, such faces may be of complementary non-planar profiles such as to cause or facilitate centralization of the second and third parts with respect to each other as the locking means 52, 54 begin to interengage and move towards their final interlocked positions.

Also, it will be appreciated by those skilled in the art, that sealing means may be provided for sealing off the annular space that will exist between the pipeline 50 and the shell assembly when installed in position on the pipeline. When grout is introduced, through an inlet (not shown) in the assembly, into the annular space the sealing means substantially prevents leakage of the grout from the annular space. The grout cures to bond the assembly into position on the pipeline and so enhance structural integrity.

Although the shell assembly according to the present invention can be particularly suitable for below-water or subsea use, it will be appreciated that it can be used in operations conducted out of water.

1. A shell assembly for securing to a tubular member, comprising:
a first part for locating on the tubular member,
second and third parts respectively movably connected to opposite sides of the first part, the second and third parts each having engaging means complementary to that of the other of te second and third parts, and
means remotely operable to move the second and third parts to respective positions whereat the complementary means interengage so that the second and third parts are secured together.

2. A shell assembly according to claim 1, in which the second and third parts are movably connected to the first part by means of respective pivotal connections about which the second and third parts are remotely movable to their respective interengaged positions.

3. A shell assembly according to claim 1, in which the remotely operable means comprise hydraulically operable means which act through pivot means to move the second and third parts with respect to the first part to interlocked positions.

4. A shell assembly according to claim 2, in which the remotely operable means comprise hydraulically operable means which act through pivot means to move the second and third parts with respect to the first part to interengaged positions.

5. A shell assembly according to claim 1, in which the second and third parts are operable to be movable generally inwardly of the positions of the second and third parts when in their interengaged positions, prior to being moved outwardly therefrom to their interengaged positions.

6. A shell assembly according to claim 2, in which the second and third parts are operable to be movable generally inwardly of the positions of the second and third parts when in their interengaged positions, prior to being moved outwardly therefrom to their interengaged positions.

7. A shell assembly according to claim 3, in which the second and third parts are operable to be movable generally inwardly of the positions of the second and third parts when in their interlocked positions, prior to being moved outwardly therefrom to their interlocked positions.

8. A shell assembly according to claim 1 in which when the second and third parts are in their respective interengaged positions, the internal cross-section of the shell assembly is generally circular.

9. A shell assembly according to claim 3 in which when the second and third parts are in their respective interlocked positions, the internal cross-section of the shell assembly is generally circular.

10. A shell assembly according to claim 1, in which the second and third parts each have a plurality of engaging means complementary to those of the other part.

11. A shell assembly according to claim 3, in which the second and third parts each have a plurality of locking means complementary to those of the other part.

12. A shell assembly according to claim 5, in which the second and third parts each have a plurality of engaging means complementary to those of the other part.

13. A shell assembly as claimed in claim 10, in which the second and third parts each have a row of formations and recesses that interlock with complementary recesses and formations of the other part to form a row of dovetail-like joints securing the second and third parts together.

14. A shell assembly as claimed in claim 11, in which the second and third parts each have a row of formations and recesses that interlock with complementary recesses and formations of the other part to form a row of dovetail-like joints securing the second and third parts together.

15. A shell assembly as claimed in claim 12, in which the second and third parts each have a row of formations and recesses that interlock with complementary recesses and formations of the other part to form a row of dovetail-like joints securing the second and third parts together.

16. A shell assembly according to claim 1, in which hydraulically operated jacking means are employed to space the second and third parts from the pipeline when the shell assembly is mounted on the pipeline with the second and third-parts in their interengaged positions.

17. A shell assembly according to claim 3, in which hydraulically operated jacking means are employed to space the second and third parts from the pipeline when the shell assembly is mounted on the pipeline with the second and third parts in their interlocked positions.

18. A shell assembly according to claim 5, in which hydraulically operated jacking means are employed to space the second and third parts from the pipeline when the shell assembly is mounted on the pipeline with the second and third parts in their interengaged positions.

19. A shell assembly according to claim 15, in which hydraulically operated jacking means are employed to space the second and third parts from the pipeline when the shell assembly is mounted on the pipeline with the second and third parts in their interengaged positions.

20. A shell assembly according to claim 16, in which the jacking means comprises a jacking member slidably mounted in an aperture in each of the second and third parts, and
respective pressure-applying means is mounted with respect to the second and third parts and behind the associated jacking member and being urgeable under hydraulic pressure against the jacking member to cause the jacking member to be urged towards the pipeline to positions to space the second and third parts from the pipeline.

21. A shell assembly according to claim 17, in which the jacking means comprises a jacking member slidably mounted in an aperture in each of the second and third parts, and
respective pressure-applying means is mounted with respect to the second and third parts and behind the associated jacking member and being urgeable under hydraulic pressure against the jacking member to cause the jacking member to be urged towards the pipeline to positions to space the second and third parts from the pipeline.

22. A shell assembly according to claim 5, in which the jacking means comprises a jacking member slidably mounted in an aperture in each of the second and third parts, and
respective pressure-applying means is mounted with respect to the second and third parts and behind the associated jacking member and being urgeable under hydraulic pressure against the jacking member to cause the jacking member to be urged towards the pipeline to positions to space the second and third parts from the pipeline.

23. A shell assembly according to claim 20, in which the jacking members are slidably mounted in bosses secured to the second and third parts, and the pressure-applying members are also slidably mounted in the bosses.

24. A shell assembly according to claim 23, in which at least one load bearing member is positioned between the pipeline and the jacking members to spread the applied load when the jacking members are in position spacing the second and third parts from the pipeline.

25. A shell assembly according to claim 24, in which each load bearing member is in the form of enlarged feet on the jacking members.

26. A shell assembly according to claim 25, in which the surfaces of the feet generally correspond to the profile of the pipeline.

27. A shell assembly according to claim 24, in which each load bearing member is secured to the pipeline in a position so that it will be engaged or contacted by the jacking members.

28. A shell assembly according to claim 26, in which a plurality of load bearing members are secured to the pipeline in positions so that they will be engaged or contacted by the jacking members.
